(19) United States
(12) Patent Application Publication
(10) Pub. No.: US 2007/0279380 A1
(43) Pub. Date: Dec. 6, 2007

(54) Computer input device

(76) Inventor: Bruno Rafael Murillo, San Ysidro, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 11/444,045

(22) Filed: May 31, 2006

(51) Int. Cl. G09G 5/08

(52) U.S. Cl. 345/161

(57) ABSTRACT

The present invention involves a computer input device that can be attached to a hand. The device includes an adjustable band that can be wrapped around the palm portion of the hand. A control housing is attached to the adjustable band. A control joystick used for controlling a computer screen cursor is attached to an end of the control housing. The joystick is angled for use with the thumb of a user and can be adjustable in length to accommodate different sized thumbs. The joystick can also be depressed to function as a button. One or more control buttons and a scrolling wheel can be located on the adjustable band near the joystick for increasing the functionality of the device. The device can communicate with a computer wirelessly or via an attached cable. The device can utilize a trackball in addition to or instead of the control joystick.

### BACKGROUND OF THE INVENTION

1. Field of the Invention

The invention relates to the field of computer input devices. More particularly, the preferred embodiment of the present invention relates to computer input devices adapted for removable engagement with the hand of a user wherein the computer curser is manipulable by the thumb of the hand. The device as disclosed can also be employed without the use of a thumb or fingers by movement of the palm of the hand and engagement of the joystick or ball on a surface.

2. Description of the Related Art

The invention of the computer mouse has greatly increased user interaction with computers by providing a computer input device that is relatively easy to learn and use. The typical mouse contains two or three buttons for controlling various software created menus on a computer screen and performing other software related functions. Additionally, by moving the mouse across a surface, a user can cause a cursor to make corresponding movements across the computer screen for performing various tasks. This is accomplished in traditional “mice” by use of a trackball and sensors located within the mouse. When the mouse is moved against a surface, the surface causes the trackball to rotate and the sensors detect the rotation and then create an electrical signal or pulse that corresponds to the rotation. This signal is then sent to the central processing unit of a connected computer to signal the movement of the cursor on the computer screen.

Many advancements have been made in the design of the mouse. For instance, some “mice” rely on optics rather than a rotating trackball to track movements of the mouse across a surface. Further, some mice have included a trackball that is placed on the top of the mouse, rather than inside the mouse, to decrease the movement of the hand or wrist. While these developments have been useful in some respects, they have not solved the problem of having to remove one's hand from the keyboard to use the mouse.

In response to this problem, some keyboard makers have placed the mouse directly on the keyboard. These inventions have either placed a touch pad or a mouse in various parts of the key board. While these configurations have helped in certain respects, they still require a user to remove his or her fingers from a typing position on the keyboard to a different location where the touch pad or trackball is located to utilize the mouse function. This procedure can cause discomfort for users and can also lead to decreased efficiency in completing several computer-related tasks.

Other inventions have tried to solve the above-mentioned problems by creating a mouse that can be worn on a hand, typically through use of a glove, and utilized while a person keeps his or her hands on the keyboard keys. These inventions, while useful in providing increased efficiency and portability, have often involved components that are uncomfortable, restraining, bulky to operate, and once being placed on a user's hand or wrist they do not allow for adjustment and they can cause injury to the hand after long term use.

Thus, there is a current need for a comfortable, adjustable, and lightweight hand attachable computer input device that is easy to use and can be utilized while keeping a user's hand on a keyboard. Such a device should also be employable for uses where a keyboard is not required and should additionally allow for manipulation of a computer curser with or without the use of the thumb or fingers on a hand to thereby accommodate disabled users who might be missing one or all the digits on one hand.

With respect to the above, before explaining at least one preferred embodiment of the invention in detail, it is to be understood that the invention is not limited in its application to the details of construction and to the arrangement of the components or steps set forth in the following description or illustrated in the drawings. The various apparatus and methods of the invention are capable of other embodiments and of being practiced and carried out in various ways which will be obvious to those skilled in the art once they review this disclosure. Also, the phraseology and terminology employed herein are for the purpose of description and should not be regarded as limiting.

Also, those skilled in the art will appreciate that the conception upon which this disclosure is based may be utilized as a basis for designing of other devices, methods and systems for carrying out the several purposes of the disclosed device. It is important, therefore, that the advantages and claims be regarded as including such equivalent construction and methodology in that they do not depart from the spirit and scope of this invention.

### SUMMARY OF THE INVENTION

It is a principle advantage of the present invention to provide a computer input device that can be attached to a hand.

It is another advantage of the present invention to provide a computer input device that can be easily adjusted to fit various hand sizes and shapes.

It is yet another advantage of the present invention to provide a computer input device that offers various buttons or features to increase the functionality of the device.

It is still another advantage of the present invention to provide a computer input device that can be quickly and efficiently manufactured.

It is a further advantage of the present invention to provide a computer input device that reduces the amount of hand or wrist movement by a user while operating a computer.

It is still a further advantage of the present invention to provide a computer input device that can be used by the thumb while the thumb is in the natural position in relation to the rest of the hand.

It is yet a further advantage of the present invention to provide a new and unique computer input device to the field of computer input devices.

These and other advantages will be apparent to one with ordinary skill in the art from the disclosure set forth herein.

The present invention involves a computer input device that can be attached to a hand. The device includes an adjustable band having that can be wrapped around the palm portion of the hand. A control housing is attached to the adjustable band. A control joystick used for controlling a computer screen cursor is attached to an end of the control housing. The joystick is angled for use with the thumb of a user and can be adjustable in length to accommodate different sized thumbs. The joystick can also be depressed to function as a button. One or more control buttons and a scrolling wheel can be located on the adjustable band near the joystick for increasing the functionality of the device. The device can communicate with a computer via an attached cable or wirelessly. The device can utilize a trackball in addition to or instead of the control joystick.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto.

### BRIEF DESCRIPTION OF THE DRAWINGS

The accompanying drawings which are incorporated in and form a part of this specification illustrate embodiments of the disclosed processing system and together with the description, serve to explain the principles of the invention.

FIG. 1 depicts a front perspective view of the preferred embodiment of the hand engageable computer input device, constructed in accordance with the present invention;

FIG. 2 depicts a top view of the preferred embodiment of the hand attachable computer input device attached to a hand, constructed in accordance with the present invention;

FIG. 3 depicts a bottom view of the preferred embodiment of the hand attachable computer input device attached to a hand, constructed in accordance with the present invention;

FIG. 4 depicts a top end view of the preferred embodiment of the hand attachable computer input device, illustrating the curvature of the control joystick toward the palm of a user, constructed in accordance with the present invention;

FIG. 5 depicts a cross-section view of a standard control joystick, constructed in accordance with the present invention;

FIG. 6 depicts a front perspective view of an alternate embodiment of the hand attachable computer input device, having a control pad, constructed in accordance with the present invention; and

FIG. 7 depicts a front perspective view of an alternate embodiment of the hand attachable computer input device, having a trackball, constructed in accordance with the present invention.

### DETAILED DESCRIPTION OF THE PREFERRED EMBODIMENTS

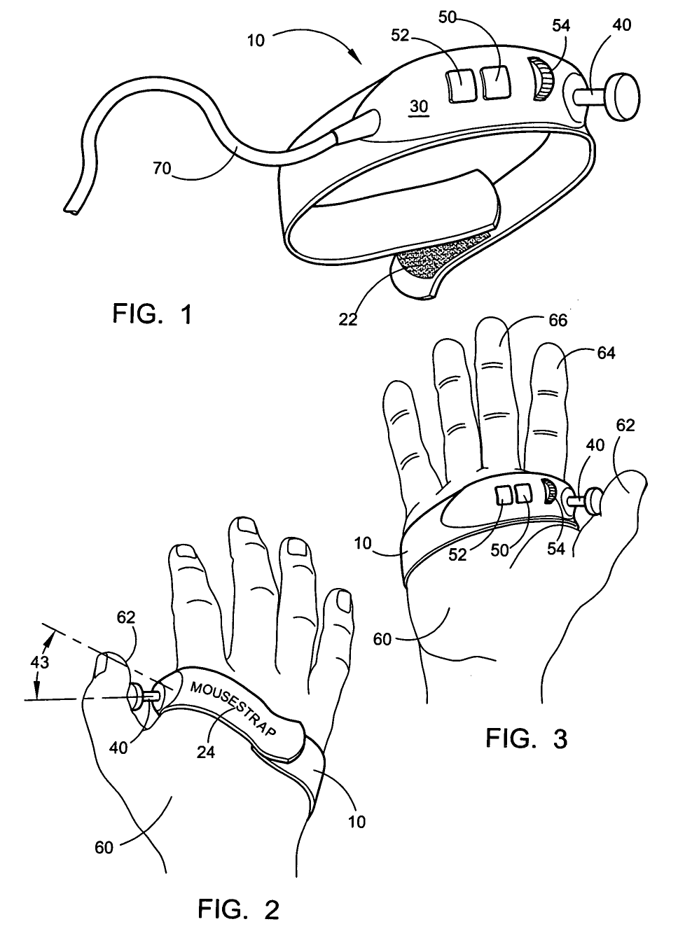

Referring now to the drawings, wherein similar parts are identified by like reference numerals, there is seen in FIG. 1, a front perspective view of the hand attachable computer input device 10 suited for a right-handed user. The device 10 is easily adapted to a left-handed user by simply rotating it 180 degrees wherein it will be adapted to removably engage with the palm of a left-handed user. One device 10 thus is easily situated to either a left or right handed user.

The device 10 includes an adjustable band 20 or other means for positioning the control housing 30 against the palm of a user in an as-worn position as shown in FIGS. 2-3. Adjustable band 20 is preferably comprised of a flexible, comfortable, and durable fabric such as nylon or soft leather. Adjustable band 20 contains adjustment means 22 that can be used to alter the size of adjustable band 20 to enable it to fit various sized and shaped hands. Adjustment means 22 can be a variety of standard adjustment mechanisms as known in the art.

Control housing 30 can be attached to adjustable band 20 by various methods including but not limited to gluing, clipping, snapping, interlocking, or other methods as would be recognized by one with ordinary skill in the art. Control housing 30 is preferably comprised of a strong and durable but lightweight material such as plastic. Of course other means to maintain the control housing 30 against the user's palm in the as-worn position may be employed as would occur to those skilled in the art. Control housing 30 houses conventional electronic circuitry providing electronic means to convert user movement of the joystick 40 or trackball 230 and/or other input buttons shown in the figures into an electrical output signal for transmission to a computer or other engaged electronic device.

User input via device 10 is collected several ways. Device 10 preferably includes means to impart directional control to the curser or highlight on an engaged computer such as a control joystick 40 attached to and partially within control housing 30. Other means to impart directional control along an XY-axis might be employed such as a trackball 230. When a user engages the device 10 in the as-worn position, the joystick 40 is positioned at an engagement end 31 of the housing 30 in a position to be comfortably engaged by the thumb of the user. Control joystick 40 is freely rotatable in a 360-degree direction, allowing a user full range of movement of control joystick 40. In the most preferred mode of the device 10, control joystick 40 is attached to control housing 30 in an angular fashion (see FIGS. 2-4) to enable a user to comfortably engage the distal end of the joystick 40 with the thumb. Control joystick 40 can also be adjustable in length to allow a user to adjust it to accommodate various sized hands. Control joystick 40 primarily serves to operate a cursor located on a computer screen or in the case of a game, to move the user's participant. However, control joystick 40 can be engaged to the device to also operate as an electronic input means if it is compressed in a downward fashion by the thumb of a user. This functionality, noted further below, allows a user to use control joystick 40 to open files, select different menus, and perform other operations that normally are performed via pressing buttons found on a traditional mouse.

Device 10 can also include other input means if such are needed for the computing device and software to which it is operably engaged. Preferably, device 10 includes one or a combination of other input means such as an outer control button 50, inner control button 52, and a scroll wheel 54. Outer control button 50 can be accessed by the pointer finger 64 of the user (see FIG. 3). Inner control button 52 can be accessed by the middle finger 66 of the user (see FIG. 3). Outer control button 50 and inner control button 52 can be used to perform various tasks such as opening menus, opening and closing files, highlighting text, and other operations that can be routinely performed by buttons found on a traditional mouse. Outer control button 50 and inner control button 52 can be programmed to function either after a user has clicked on them once or after a user has clicked on them twice. Scroll wheel 54 a conventional scroll wheel that can be used to quickly and conveniently scroll through a document or web page. Of course these other input means can be situated upon the device at different points depending on the intended engagement with the hand in the as-worn position. The number of input means may vary depending on whether the device is engaged to a personal computer, a TV, a video game, or other electronic device in need of user input.

Device 10 has means for electronic communication with a computer in the form of a cord 70 that is preferably attached to control housing 30. Cord 70 is adapted to connect operatively to a computer and serves primarily as a conduit for the transmission of electronic signals from device 10 to the computer and the feedback of information from the computer to device 10. Cord 70 can vary in length to provide convenience to a user and can be configured to plug into either a USB port, a serial port, a Ps2 port, or other input ports of a computer.

In other embodiments, the device employs a transmitter and receiver located within control housing 30 for communicating wirelessly with a computer as a means for electronic communication with the computer. This wireless transmission or WiFi, can occur over conventional frequencies as would be recognized by one with ordinary skill in the art.

FIG. 2 depicts a top view of device 10 attached to a hand 60 of the user in the as-worn position. This figure illustrates the most preferred mode of the device 10 employing an angular orientation of control joystick 40 away from the palm of the hand with the distal end of the joystick 40 placed toward and adjacent to the distal end of the thumb 62 of a user. This angular orientation positions the joystick 40 or other means to direct a cursor along an XY axis and allows a user to operate control joystick 40 using the thumb 62 is in a more natural position, rather than forcing a user to strain the thumb into an uncomfortable position to use control joystick 40. The angular positioning of control joystick 40, represented by numeral 43, is preferably about between 10-45 degrees with a current preferred mode of the device having an angle of 20 degrees form the center axis of the device 10 which runs substantially parallel to the palm when the device is in the as-worn position. The angle 43 may be fixed during manufacture in the basic version of the device 10 to extend away from the engagement end 31 at a determined angel in the range noted. Or, in a more adjustable mode of the device 10, the engagement end 31 of the housing 30 may be rotationally engaged using a means for rotational engagement such as a hinged engagement 33 or a hinge and ratchet engagement of the engagement end 31 and the housing 30 or a ball and socket engagement or other such means for rotational engagement. If rotationally engaged, the angle 43 may be adjusted to the size of the hand and thumb of the user allowing for a custom fit to place the joystick 40 or trackball 230 in a proper position for easy manipulation by the user's thumb in a natural position while the device is in the as-worn position.

Device 10 can also include indicia 24 located on adjustable band 20. Indicia 24 can include various numbers, letters, symbols, shapes, words, pictures, or other indicia. Indicia 24 can be printed, stitched, sewn, on adjustable band 20.

FIG. 3 depicts a bottom view of the device 10 attached to hand 60 in the as-worn position. This figure illustrates the positioning of outer control button 50, inner control button 52, and scroll wheel 54 control button, in relation to hand 60, as well as the angular positioning of control joystick 40 in relation to thumb 62.

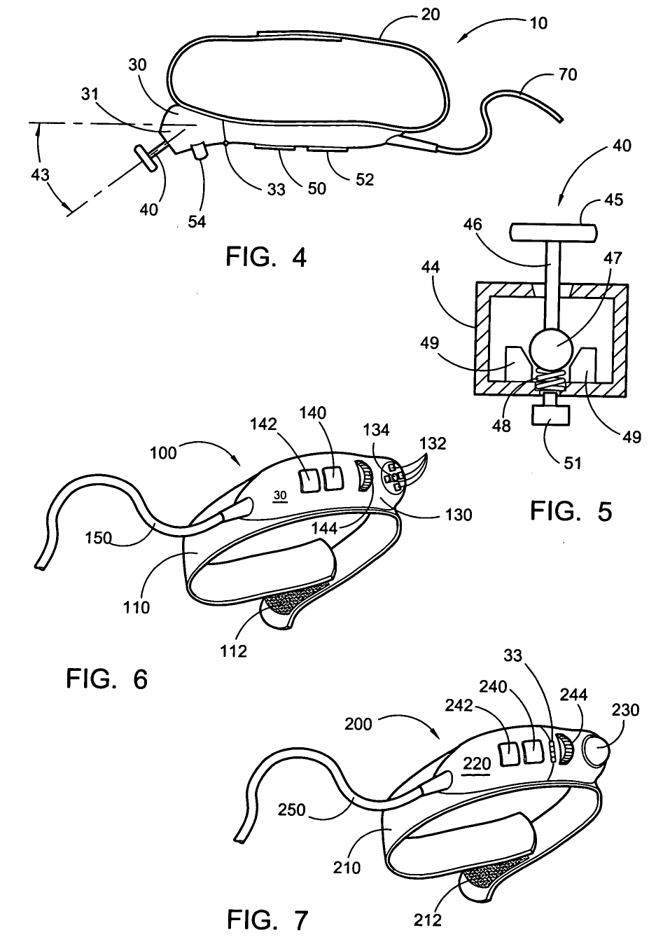

FIG. 4 depicts a top end view of device 10 positioned for a left-handed user. This figure illustrates the curvature of an external surface of the device 10 thereby adapted to comfortably fit the palm of a user in an as-worn position. Control housing 30 is dimensioned to fit against the palm of a user to allow a user to operate control joystick 40 which is angled toward its distal end, to place it adjacent to the thumb 62 when in its natural resting position. The surface of the distal end of the thumb in a neutral or resting position is generally in a horizontal or vertical plane spaced from the surface of the palm of the hand 60. Rather than forcing a user to strain the thumb into an uncomfortable position to use control joystick 40, the device 10 employs the depicted and described angled engagement of the joystick 40 such that its distal end is positioned for easy and comfortable engagement by the thumb. The angular positioning of control joystick 40 away from the axis along the palm of a user, represented by numeral 43, is preferably about 20 degrees. The angled engagement is of course a preferred component of the device 10 in its best mode. However, control joystick 40 can be angled toward the palm at an angle 43 ranging anywhere between 10-45 degrees.

FIG. 5 depicts a cross-section generalized view of the internal workings of the device 10 showing an example of the means to convert user input from the joystick 40 or trackball 230 into an electrical output signal communicated to a computing device. As depicted, control joystick 40 includes a joystick housing 44, a head 45, a shaft 46, a ball member 47, a spring 48, and at least one motion sensor 49. Such motion sensors can be optical and sensing movement of the ball member 47 in the form of an LED or laser and a pickup device which senses movement of the ball member 47 in two directions. Or motion sensor 49 may be conventional analog wherein the ball member 47 rotates a pair of wheels which provide input of direction along an XY axis, or it may also be magnetic sensing.

To use joystick 40 as a means for directional input for a computer curser engaged to the device 10, a user exerts pressure in a particular direction on head 45, causing shaft 46 and ball member 47 to rotate in directions along an XY axis. The motion sensor 49, be it optical or analog or other means to sense movement in the two directions of an XY axis, senses the movement of the ball member 47 and converts it to an electronic signal useable by the attached computing device to thereby direct curser or other screen movement.

As noted, in a particularly preferred mode to limit the removal of the thumb the joystick 40 may also be used as an input means or input button and perform various button-related tasks such as opening and closing files and menus which are conventionally done when the curser is properly positioned by movement along the XY axis. Making the joystick 40 depressable to overcome upward biasing of spring 48 to thereby activate a switch 51 providing an input allows the user to employ the device to also perform drag-and-drop and similar functions. This function can also be employed with other embodiments of the device 10 which use a trackball or other means for directional movement of the curser on an engaged computer.

FIG. 6 depicts a front perspective view of an alternate embodiment of the hand attachable computer input device 100. Device 100 includes a means to position the device against the palm of a user in the as-worn position in the form of an adjustable band 110 engaged to the control housing 30. Adjustable band 110 is preferably comprised of a flexible, comfortable, and durable fabric such as nylon or soft leather. Adjustable band 110 contains adjustment means 112 that can be used to alter the size of adjustable band 110 to enable it to fit various sized and shaped hands. Adjustment means 112 can be a variety of standard adjustment mechanisms as known in the art.

Control housing 30 can be attached to adjustable band 110 by various methods including but not limited to gluing, clipping, snapping, interlocking, or other methods as would be recognized by one with ordinary skill in the art. Control housing 30 is preferably comprised of a strong and durable material such as plastic. Control housing 30 houses various electronic circuitry as noted earlier to convert user manual input into electrical output signals for transmission to a computer.

User input via device 100 is collected several ways. Device 100 preferably includes a directional pad 130 located on control housing 30 where the joystick of FIG. 1 would extend. When a user wears device 100, in the preferred mode, the pad 130 is positioned at an angle at the end of the hand facing the thumb, such that directional pad 130 can be engaged by the thumb of the user while in a natural position spaced from the palm. Directional pad 130 preferably contains four directional input buttons 132, one for up, down, right, and left, allowing a user full ranges of movement of a cursor located on a computer screen. In additional to directional buttons 132, directional pad 130 can also contain an omni-directional button 134 centrally located between directional buttons 132. Button 134 can freely rotate in a 360-degree direction, allowing users joystick-type functionality as well as buttons that are solely dedicated to one directional movement. Omni-directional button 134 can also serve as a clicking button, whereby a user can press directly down on button 134 to allow a user to open files, select different menus, and perform other operations that normally are performed via pressing buttons found on a traditional mouse.

Device 100 can include other mechanically activated electronic input means. Preferably, device 100 includes an outer button 140, inner button 142, and a scroll wheel 144. Outer button 140 can be accessed by the pointer finger of the user. Inner button 142 can be accessed by the middle finger of the user. Outer button 140 and inner button 142 can be used to perform various tasks, such as opening menus, opening and closing files, highlighting text, and other functions routinely performed by buttons found on a traditional mouse. Outer button 140 and inner button 142 can be programmed to function either after a user has clicked on them once or twice. Scroll wheel 144 is a standard scroll wheel that can be used to quickly and conveniently scroll through a document or web page.

Device 100 can also include a cord 150 that is preferably attached to control housing 120. Cord 150 can be connected to a computer and serves primarily as a conduit for the transmission of information from device 100 to the computer and the reception of information from the computer to device 100. Cord 150 can vary in length to provide convenience to a user, and can be configured to plug into either a USB port or a serial port or other conventional computer port, engaged to a computer. In other embodiments, the hand attachable computer input device does not utilize a cord 150, but rather contains a transmitter and receiver located within control housing 120 for communicating wirelessly with a computer. This wireless transmission can occur over various frequencies as would be recognized by one with ordinary skill in the art.

FIG. 7 depicts a front perspective view of an alternate embodiment of the hand attachable computer input device 200. Device 200 includes an adjustable band 210 and a control housing 220 attached thereto. Adjustable band 210 is preferably comprised of a flexible, comfortable, and durable fabric such as nylon or soft leather, and provides means to position the device 200 in the as-worn position. Adjustable band 210 contains adjustment means 212 that can be used to alter the size of adjustable band 210 to enable it to fit various sized and shaped hands. Adjustment means 212 can be a variety of standard adjustment mechanisms as known in the art.

Control housing 220 can be attached to adjustable band 210 by various methods including but not limited to gluing, clipping, snapping, interlocking, or other methods as would be recognized by one with ordinary skill in the art. Control housing 220 is preferably comprised of a strong and durable material such as plastic and houses various electronic circuitry that convert user mechanical input into electrical output for transmission to a computer. Housing 220 in the preferred mode would have the angled engagement end 31 having either a fixed angle toward the distal end of the user's thumb in an as-worn position, or employ means for rotational engagement such as a hinged engagement 33 or a hinge and ratchet engagement of the engagement end 31 and the housing 30 or a frictionally restrained ball and socket engagement or other such means for rotational engagement.

User input via device 200 is collected several ways. Device 200 preferably includes a trackball 230 located on control housing 220. Trackball 230 is a conventional trackball device as would be recognized by one with ordinary skill in the art. When a user wears device 100, it is intended that trackball 230 is positioned at the end of the hand facing the thumb, such that trackball 230 can be engaged by the thumb of the user. Trackball 230 is attached to control housing 220 in an angular fashion, both horizontally and vertically, to enable a user to comfortably use it with the thumb. Trackball 230 can freely rotate in a 360 degree direction, allowing users joystick-type functionality. Trackball 230 can also serve as a clicking button as noted for the trackball above, whereby a user can press directly down on trackball 230 to allow a user to open files, select different menus, and perform other operations normally performed via pressing buttons on a traditional mouse.

Device 200 can include other input means. Preferably, device 200 includes an outer button 240, inner button 242, and a scroll wheel 244. Outer button 240 can be accessed by the pointer finger of the user. Inner button 242 can be accessed by the middle finger of the user. Outer button 240 and inner button 242 can be used to perform various tasks such as opening menus, opening and closing files, highlighting text, and other operations that can be routinely performed by buttons found on a traditional mouse. Outer button 240 and inner button 242 can be programmed to function either after a user has clicked on them once or after a user has clicked on them twice. Scroll wheel 244 is a standard scroll wheel that can be used to quickly and conveniently scroll through a document or web page.

Device 200 can also include a cord 250 that is preferably attached to control housing 220. Cord 250 can be connected to a computer and serves primarily as a conduit for the transmission of information from device 200 to the computer and the reception of information from the computer to device 200. Cord 250 can vary in length and can plug into either a USB port or a serial port located within a computer. In other embodiments, the hand attachable computer input device does not use a cord 250, but rather contains a transmitter and receiver located within control housing 220 for communicating wirelessly with a computer. This wireless transmission can occur over various frequencies.

The device herein shown in the drawings and described in detail herein disclose arrangements of elements of particular construction and configuration for illustrating preferred embodiments of structure of the present invention. It is to be understood, however, that elements of different construction and configuration, and different steps and process procedures, and other arrangements thereof other than those illustrated and described may be employed for providing a cable locating device formed thereof in accordance with the spirit of this invention.

As such, while the present invention has been described herein with reference to particular embodiments thereof, a latitude of modifications, various changes and substitutions are intended in the foregoing disclosure, and will be appreciated that in some instance some features of the invention could be employed without a corresponding use of other features, without departing from the scope of the invention as set forth in the following claims. All such changes, alternations and modifications as would occur to those skilled in the art are considered to be within the scope of this invention as broadly defined in the appended claims.

Further, the purpose of the foregoing abstract is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting, as to the scope of the invention in any way.

I claim:

1. A computer input device adapted for removable engagement against the palm of a hand of a user in an as-worn position, comprising:
an elongated control housing;
means to position said control housing with a first exterior surface against the palm of a hand of a user in an as-worn position;
a control means having a first end extending from an engagement end of said control housing, and having a distal end;
a first means to generate a first electronic signal, relative to directional movement of said control means; and
means to communicate said first electronic signal to a computing device whereby said first electronic signal moves a curser or other computer generated video visual display.

2. The computer input device of claim 1 additionally comprising:
means for angled engagement of said control means from said engagement end, at a defined angle away from said palm; and
said defined angle providing means to position said distal end of said control means adjacent to the thumb of said hand.

3. The computer input device of claim 2 wherein said means for angled engagement is an angled engagement of said first end of said control means, from a mount located at said engagement end.

4. The computer input device of claim 2 wherein said means for angled engagement is a means for rotational engagement of said engagement end of said control housing to said elongated control housing whereby said defined angle may be adjusted to the individual hand characteristics of said hand.

5. A computer input device of claim 1 additionally comprising:
a second means to generate a second electronic signal;
said second means to generate said second electronic signal activated to generate said second electronic signal by depression of said distal end of said control means toward said control housing; and
means to communicate said second electronic signal to said computing device.

6. A computer input device of claim 2 additionally comprising:
a second means to generate a second electronic signal;
said second means to generate said second electronic signal activated to generate said second electronic signal by depression of said distal end of said control means toward said control housing; and
means to communicate said second electronic signal to said computing device.

7. A computer input device of claim 3 additionally comprising:
a second means to generate a second electronic signal;
said second means to generate said second electronic signal activated to generate said second electronic signal by depression of said distal end of said control means toward said control housing; and
means to communicate said second electronic signal to said computing device.

8. A computer input device of claim 4 additionally comprising:
a second means to generate a second electronic signal;
said second means to generate said second electronic signal activated to generate said second electronic signal by depression of said distal end of said control means toward said control housing; and
means to communicate said second electronic signal to said computing device.

9. The computer input device of claim 1, wherein said control means is a joystick.

10. The computer input device of claim 2, wherein said control means is a joystick.

11. The computer input device of claim 3, wherein said control means is a joystick.

12. The computer input device of claim 4, wherein said control means is a joystick.

13. The computer input device of claim 5, wherein said control means is a joystick.

14. The computer input device of claim 9, wherein said joystick is adjustable in length for the purpose of accommodating various hand sizes.

15. The computer input device of claim 10, wherein said joystick is adjustable in length for the purpose of accommodating various hand sizes.

16. The computer input device of claim 1, wherein said control means is a trackball.

17. The computer input device of claim 2, wherein said control means is a trackball.

18. The computer input device of claim 4, wherein said control means is a trackball.

19. The computer input device of claim 8, wherein said control means is a trackball.

20. The computer input device of claim 6 additionally comprising:
at least one control button attached to said control housing;
said control button providing means to activate a third means to generate a third electronic signal when touched by said thumb or a finger of said hand of said user; and
means to communicate said third electronic signal to said computing device.
